(19) United States
(12) Patent Application Publication
(10) Pub. No.: US 2009/0257242 A1
(43) Pub. Date: Oct. 15, 2009

(54) LIGHT-EMITTING DEVICES AND RELATED METHODS

(76) Inventor: Mark WENDMAN, Fremont, CA (US)

Correspondence Address: MORRISON & FOERSTER LLP, 755 PAGE MILL RD, PALO ALTO, CA, 94304-1018, US

(21) Appl. No.: 12/421,554

(22) Filed: Apr. 9, 2009

Related U.S. Application Data
(60) Provisional application No. 61/043,618, filed on Apr. 9, 2008.

(51) Int. Cl. H01S 3/00; F21V 9/16

(52) U.S. Cl. 362/553; 362/84

(57) ABSTRACT

Light-emitting devices and related methods are described that involve spatially distributing the light emission from a primary light source such as a laser or LED before it is incident on the photoluminescent material. The photoluminescent material emits a secondary emission that may comprise visible light. Some variations of the light-emitting devices may utilize an optical waveguide to couple-in light from the primary light source and spatially distribute the coupled-in light in a controlled manner to pump the photoluminescent material. A variety of configurations for high efficiency light fixtures may be possible using the light-emitting devices and methods described herein.

### CROSS-REFERENCE TO RELATED APPLICATIONS

This application claims the benefit of priority to U.S. App. Ser. No. 61/043,618 filed Apr. 9, 2008, inventor, Mark Wendman, entitled “LIGHT EMITTING DEVICES AND RELATED METHODS” the contents of which are incorporated by reference in their entirety herein. This application is also related to the PCT application entitled “LIGHT EMITTING DEVICES AND RELATED METHODS,” inventor Mark Wendman filed on even date herewith, which is incorporated by reference in its entirety as if put forth in full below.

### FIELD

Disclosed here are light-emitting devices and related methods. The light-emitting devices and methods generally utilize photoluminescent materials that are pumped with lasers or light-emitting diodes.

### BACKGROUND

A significant fraction of the world's energy is used for lighting. Incandescent light bulbs can be very inefficient, emitting much of their energy as heat rather than as light. In addition, incandescent light bulbs may burn out on a relatively short timescale, e.g., about a thousand hours. Fluorescent light bulbs, while generally more efficient than incandescent light bulbs, may still lose a significant fraction of their energy as non-light emission. Further, the emission spectrum of typical fluorescent light bulbs may not be optimal for the human eye.

Semiconductor-based light sources such as semiconductor lasers, laser diodes, and light-emitting diodes (LEDs) may be more efficient photon-generators than incandescent light sources. However, semiconductor light sources may have narrow wavelength emissions, e.g., in the red, blue, or ultraviolet (UV) regions of the visible spectrum. Red, green, blue and white phosphors have been used to convert UV emission from LEDs to visible light.

Therefore, a need exists for improved devices and methods for conversion of emission from LEDs and semiconductor lasers to bands of light that may be used as visible light sources. For example, a need exists for the conversion of emission from LEDs and semiconductor lasers to a usable light output comprising a relatively broad spectrum of visible light, near white light, or white light.

### SUMMARY

Described herein are a variety of devices and methods that apply emission from a laser or LED to a photoluminescent material, e.g., a phosphor, to generate a desired band of light for lighting applications, e.g., visible light, white light, or near white light. Described herein are devices and methods that include spatially distributing the light emission from a primary light source, e.g., a laser or LED, before the primary light emission is incident on a photoluminescent material. By spatially distributing the light emission from a primary light source, improved excitation of the photoluminescent material may be achieved in some instances without the need for mirrors, lenses, and the like, e.g., by improving uniformity of excitation and/or maintaining a peak intensity of the pump light below a damage and/or saturation threshold of the photoluminescent material. Further, the desired emission from the photoluminescent material may be spatially distributed in a manner generally corresponding to the distribution of the primary excitation light, allowing for a variety of configurations of light fixtures, e.g., elongated or compact light fixtures for room lighting, and light fixtures with flexible light sources (e.g., “flexible light bulbs”).

Some variations of devices include an optical waveguide and a photoluminescent material. In these devices, the optical waveguide is configured to couple in light emitted by a primary light source, to at least partially guide the coupled-in light along a length of the optical waveguide, and to divert at least a portion of the coupled-in, guided light from the core of the waveguide to provide distributed light loss. The photoluminescent material is configured to be pumped by the distributed light loss and to emit a secondary light emission that comprises visible light. The secondary light emission from the devices may comprise emit red, green, yellow, and/or white light. The devices may be configured for use in a lighting fixture. The secondary emission from some devices may have a luminous flux of at least about 30 lumens.

The primary light source used by the devices may be any suitable light source, and the primary light source may emit light over any suitable wavelength range. In some variations, the primary light source may comprise a laser, e.g., a semiconductor laser such as a laser comprising GaN or a GaN alloy as a lasing medium, or a LED, e.g., a GaN LED or a GaN alloy LED. The primary light source may emit light having a wavelength in a range from about 250 nm to about 500 nm, e.g., about 250 nm, about 300 nm, about 350 nm, about 400 nm, about 450 nm, or about 500 nm. Some devices may include the primary light source, e.g., as an integral or adjoined component, whereas other devices may utilize a primary light source that is remote from the devices, e.g., a central primary light source that is configured to pump multiple devices. A peak intensity of the leaked distributed light may be below a damage threshold and/or below a saturation threshold of the photoluminescent material.

The optical waveguide used in the devices may be any suitable type of waveguide. The optical waveguide may comprise a single mode waveguide region, e.g., for those devices in which the primary light source is a laser. In other variations, the optical waveguide may comprise a multi-mode waveguide core, e.g., a large core multi-mode waveguide region. Large core multi-mode waveguide regions may for example be used in those devices in which the primary light source exhibits relatively low optical coherence, such as an LED. The optical waveguide may comprise a combination of waveguide types, e.g., a waveguide may comprise a taper region wherein a large core region of the optical waveguide (which in some instances may be a multi-mode region) is tapered to a smaller core region of the optical waveguide. In certain variations, the optical waveguide may comprise one or more photonic crystal fibers.

The optical waveguide may be configured in any suitable manner to couple in light from the primary light source, to at least partially guide the coupled-in light along a length of the waveguide, and to provide distributed light loss from the waveguide core with which to pump the photoluminescent material. For example, in some variations, the optical waveguide may be configured to split at least a portion of the guided primary light into multiple beams, e.g., devices may comprise one or more taps and/or splitters configured to split guided light into multiple beams. At least one of the multiple beams may be diverted from the core of optical waveguide to provide at least a portion of the distributed light loss.

Alternatively or in addition, the optical waveguide in these variations of devices may comprise one or more scattering regions configured to scatter at least a portion of the guided light, and to divert at least a portion of the scattered light out of the core of the waveguide to pump the photoluminescent material. For example, the optical waveguide may comprise one or more roughened regions, and each roughened region may be configured to scatter at least a portion of the guided primary light. The optical waveguide may comprise one or more graded index regions, and each graded index region may be configured to scatter at least a portion of the guided primary light.

In still other variations of devices, the optical waveguide may comprise at least one index-confinement region that is configured to provide a desired amount of leakage of the guided light from the core of the waveguide, and the distributed light loss may comprise light leaked out of the core of the waveguide from the at least one index-confinement region. In certain variations, the optical waveguide may comprise a taper region where the core is tapered from a large core region, e.g., a multi-mode region, to a smaller core region, e.g., a single mode region, and the light that is not accepted by the smaller core region may be used to pump a photoluminescent material.

In some devices, the optical waveguide may comprise at least one bend region. In these variations, the distributed light loss used to pump the photoluminescent material may comprise light diverted out of the core of the optical waveguide from the at least one bend region. In some variations of devices, the optical waveguide may comprise a proximal end and a distal end, and the at least one bend region may comprise a coiled region. The radius of curvature of the coiled region may in some variations be relatively constant between the proximal and distal ends, and in other variation the radius of curvature may decrease from the proximal end to the distal end.

In certain variations, the optical waveguide may comprise a central longitudinal axis extending along the length of the optical waveguide, and at least a portion of the distributed light may be emitted in a direction that is generally orthogonal to the central longitudinal axis. For example, the distributed light loss may be at least partially isotropic in two dimensions that are each generally orthogonal to the central longitudinal axis, e.g., the distributed light may be emitted generally radially from the central longitudinal axis.

The photoluminescent material may be any suitable material. For example, the photoluminescent material may comprise a phosphorescent compound selected from the group consisting of cerium-containing compounds, yttrium-containing compounds, gadolinium-containing compounds, scandium-containing compounds, lanthanum-containing compounds, lutetium-containing compounds, terbium-containing compounds, and combinations thereof. The photoluminescent material may comprise a continuous layer, may comprise a discontinuous layer, and/or may comprise a composite material, e.g., photoluminescent particles dispersed in a matrix. For example, photoluminescent particles may be dispersed in a matrix in the cladding and/or core of the waveguide. Devices may comprise more than one photoluminescent material, e.g., some devices may comprise a group of photoluminescent materials. Where a group of photoluminescent materials are used, each photoluminescent material may be selected to emit light over a different wavelength range of visible light.

The photoluminescent material may be arranged in any suitable manner relative to the waveguide in these devices. The photoluminescent material may comprise one or more photoluminescent regions, and a spatial distribution of the one or more photoluminescent regions may be at least partially coordinated with a spatial distribution of the distributed light loss emanating from core of the waveguide. In some variations, the photoluminescent material may be disposed along at least a portion of the length of the optical waveguide, e.g., either continuously or periodically. In certain variations, the photoluminescent material may be disposed in and/or on the core of the optical waveguide. Alternatively or in addition, the photoluminescent material may be disposed in and/or on a cladding of the optical waveguide. The optical waveguide may comprise a central core configured to guide the primary light, and an annular guiding structure that surrounds the central core and comprises the photoluminescent material. In some instances, the central core may be hollow. At least a portion of the distributed light loss may be directed outward from the central core toward the annular guiding structure comprising the photoluminescent material.

Some variations of devices may comprise one or more filters and/or other mechanical and/or optical elements configured to at least partially attenuate and/or block stray light having the same wavelength as the light from the primary light source. For example, spatial and/or optical filters may be used to block stray primary light, e.g., ultraviolet primary light. Certain devices may include one or more filters, mechanical elements and/or optical elements configured to at least partially separate the secondary emission from light having the same wavelength as the light from the primary light source, e.g. one or more spatial and/or optical filters.

The devices may further comprise a coupler that is configured to couple the light emitted from the primary light source into the waveguide. The coupler may be selected from the group consisting of a ball lens coupler, an aspheric lens coupler, a grating coupler, a butt coupler, an index coupler, a reverse core waveguide taper coupler, a direct coupler such as a Namiki-type spherical or cylindrical lensed fiber coupler, and combinations thereof.

Methods for generating light are also provided here. In general, the methods include coupling light from a primary light source into an optical waveguide so that the coupled-in light is guided along a length of the optical waveguide, and pumping a photoluminescent material with guided light that has been leaked out of a core of the optical waveguide so that the photoluminescent material emits a secondary light emission that comprises visible light, e.g., white light. The methods may comprise pumping the photoluminescent material with an intensity of leaked light that is below a damage and/or saturation threshold of the photoluminescent material.

The methods may utilize any suitable primary light source. For example, in some variations, the primary light source may comprise a laser, e.g., a semiconductor laser such as a laser comprising GaN or a GaN alloy as a lasing medium. In other variations of the methods, the primary light source may comprise a light-emitting diode, e.g., a GaN LED or a GaN alloy LED. The primary light source may emit light having a wavelength in a range from about 250 nm to about 500 nm, e.g., about 250 nm, about 300 nm, about 350 nm, about 400 nm, about 450 nm, or about 500 nm.

The methods may utilize any suitable type of waveguide and/or mechanism to cause guided light to be leaked out of the core of the waveguide. For example, the methods may comprise splitting a portion of the guided light and diverting the split portion from the core of the optical waveguide to provide at least a portion of the leaked light. Some methods may comprise scattering guided light out of the core to provide at least a portion of the leaked light. Certain methods may comprise using a waveguide that comprises one or more bend regions configured to leak guided light out of the core of the waveguide. Methods may comprise tapering a large core multi-mode region of the waveguide to a smaller core region of the waveguide, and using scattered intensity due to light (e.g., modes) that does not couple into the smaller core region to pump the photoluminescent material. In some methods, the waveguide used may comprise one or more photonic crystal fibers.

Some methods may further comprise at least partially blocking and/or attenuating stray light having the same wavelength as the light from the primary light source. Certain methods may comprise at least partially separating the secondary light emission from light having the same wavelength as the light from the primary light source.

Other methods for generating light are described here. These methods comprise distributing light from a primary light source over an area to create spatially distributed light, and pumping a photoluminescent material with the spatially distributed light so that the photoluminescent material emits a secondary light emission that comprises visible light, e.g., white light. The methods may comprise distributing the light from the primary light source to provide a substantially uniform light intensity over the area. Some methods may comprise distributing light from the primary light source such that a peak intensity of the spatially distributed light is below a damage and/or saturation threshold of the photoluminescent material.

These methods may involve distributing light from any suitable primary light source, e.g., a laser, or an LED. For example, the methods may comprise distributing light emitted from a semiconductor laser, e.g., a laser that comprises GaN or a GaN alloy as a lasing medium. The methods may in some cases comprise pumping the photoluminescent material with the spatially distributed light so that the secondary light emission has a luminous flux of at least about 30 lumens.

Methods for making a light source are described here. These methods comprise providing an optical waveguide that is configured to couple in light from a primary light source, to at least partially guide the coupled-in light along a length of the optical waveguide, and to divert at least a portion of the guided light out of a core of the waveguide to create spatially distributed light, and configuring the spatially distributed light for use as a light source. The methods may for example comprise pumping a photoluminescent material with the spatially distributed light and using secondary emission from the photoluminescent material as the light source.

Some variations of these methods may comprise providing one or more optical loss regions that are disposed along the length of the waveguide, wherein each optical loss region is configured to divert guided light out of the core of the waveguide to provide at least a portion of the spatially distributed light. In these variations, providing one or more optical loss regions may comprise forming one or more bends and/or one or more roughened regions in the optical waveguide.

In the variations of the methods comprising forming one or more bends in the waveguide to provide one or more optical loss regions, bends may be designed to have any suitable optical loss properties. Some methods may comprise forming a bend such that an index-confinement condition of the bend provides a desired amount of optical loss from that bend. The methods may comprise forming bends using any suitable technique. For example, forming a bend may comprise exposing a bend portion of the optical waveguide to a spark discharge to locally heat the bend portion and bending the bend portion to form the bend. In these variations, a mold and/or a fixture may be used to control bending of the bend portion. A bend may be formed to a pre-determined bend radius to provide a desired amount of optical loss from the bend.

In the variations of the methods comprising forming one or more roughened regions in the waveguide to provide one or more optical loss regions, roughened regions may be formed by any suitable technique. For example, roughened regions may be formed by etching and/or mechanical roughening. Plasma etching, ion bombardment, sputter etching, wet etching, grinding, sanding, texturing, melt texturing, cutting, sawing, and combinations thereof may be used to form roughened regions in the waveguides.

Variations of the methods may comprise providing a coupler to couple the light from the primary light source into the optical waveguide. In these methods, the coupler may be selected from the group consisting of a ball lens coupler, an aspheric lens coupler, a grating coupler, a butt coupler, an index coupler, a reverse core waveguide taper coupler, a direct coupler such as a Namiki-type spherical or cylindrical lensed fiber coupler, and combinations thereof.

Light fixtures are also described here. In general, the light fixtures comprise a visible light source and a light fixture body. The visible light source used in the light fixtures comprises an optical waveguide and a photoluminescent material. The optical waveguide is configured to couple in light from a primary light source, to at least partially guide the coupled-in light along a length of the waveguide, and to divert at least a portion of the guided light out of a core of the waveguide to provide distributed light loss. The photoluminescent material is configured to absorb the distributed light loss from the waveguide core and to emit a secondary light emission that comprises visible light, e.g., red light, yellow light, green light, white light, or a combination thereof. Some variations of light fixtures may comprise the primary light source, e.g., as an integral component or adjoined component of the light fixture.

The light fixtures may be configured to couple in light from any suitable primary light source. For example, some variations of light fixtures may be configured to couple in primary light having a wavelength in a range from about 250 nm to about 500 nm, e.g., about 250 nm, about 300 nm, about 350 nm, about 400 nm, about 450 nm, or about 500 nm. Light fixtures may couple in light from a laser, e.g., a semiconductor laser such as a GaN laser or a GaN alloy laser. Certain variations of light fixtures may couple in light from a LED, e.g., a GaN LED or a GaN alloy LED.

The light fixtures in general may be configured for room lighting, and in some variations may be configured to have a luminous flux of at least about 30 lumens. Light fixtures may have any suitable shape, size and configuration. In some variations, the light fixtures may be elongated, e.g., to traverse along part of a ceiling or wall. In other variations, the light fixtures may have a compact configuration, e.g., to fit in a light fixture body similar in arrangement, dimension, and/or size as one designed for an incandescent bulb. The light fixture body of certain light fixtures may comprise one or more reflective elements that are configured to direct the visible light emitted by the photoluminescent. Certain variations of the light fixtures may comprise one or more filters or other mechanical or optical elements configured to at least partially block and/or attenuate stray light having the same wavelength as light from the primary light source. For example, spatial and/or optical filters may be used to block stray or unwanted primary light for safety reasons.

### BRIEF DESCRIPTION OF THE FIGURES

FIG. 1 illustrates a variation of a device comprising a planar waveguide in which light is scattered out of a core region of the waveguide to pump a photoluminescent material.

FIGS. 2A-2B illustrates variations of a device comprising a planar waveguide.

FIGS. 3A-3D illustrate additional variations of light-emitting devices.

FIG. 4 illustrates a variation of a device in which the location of photoluminescent material regions is coordinated with light scattering regions in the core of a waveguide.

FIG. 5 illustrates a variation of a device in which scattered light is directed away from a central longitudinal axis of a rectangular waveguide to pump a photoluminescent material.

FIG. 6 illustrates a variation of a device comprising a photonic crystal fiber.

FIG. 7A-illustrates a variation of devices comprising a hollow core waveguide.

FIGS. 7B-7D illustrate examples of devices having various distributions of photoluminescent materials in a waveguide cladding.

FIG. 8 illustrates a variation of a device comprising an optical waveguide comprising a bend, in which light loss from the bend pumps a photoluminescent material.

FIG. 9 illustrates a variation of a device comprising an optical waveguide having a coiled region.

FIG. 10 illustrates a variation of a device that includes a primary light source.

FIGS. 11A-11B illustrate an elongated variation of a light fixture.

FIG. 12 illustrates a compact variation of a light fixture.

### DETAILED DESCRIPTION

Described here are a variety of devices and related methods in which emission from primary light source, e.g., a laser or LED, is incident on a photoluminescent material, e.g., a phosphor. The photoluminescent material then emits a secondary emission to generate a desired band of light, e.g., visible light that may be used for lighting applications. In general, the devices and methods involve spatially distributing the light emission from the primary light source before it is incident on the photoluminescent material. By spatially distributing the light emission from a light source, improved excitation of the photoluminescent material may be achieved, e.g., by allowing for more uniform illumination and/or illumination over a relatively larger area of a photoluminescent material, in some instances without the need for extra optical elements such as mirrors, lenses and the like. The device and methods may also maintain a peak intensity of the pump light below a damage and/or saturation threshold of the photoluminescent material. In these devices and methods, the secondary emission from the photoluminescent material may be spatially distributed in a manner generally corresponding to the distribution of the primary excitation light, allowing for a variety of configurations for light fixtures. For example, elongated light fixtures for room lighting, compact light fixtures for room lighting or more localized lighting, and light fixtures with flexible light sources (e.g., “flexible light bulbs”) are possible with the devices and methods described herein.

As used herein, the term “photoluminescent material” is meant to encompass any material that absorbs incident light and then emits light, e.g., as phosphorescence and/or fluorescence. As used herein, the term “stray light” is meant to encompass any light that is not desired for a specific use in the devices and methods described herein, e.g., light from a primary light source that is scattered, reflected, refracted, transmitted or otherwise directed to an unintended or undesired location.

### Devices for Generating Light

In general, the devices for generating light described here include a means for spatially distributing primary light and a photoluminescent material for at least partially absorbing the spatially distributed light and emitting phosphorescence and/or fluorescence as secondary emission. In some variations of devices, the means for spatially distributing primary light may comprise an optical waveguide. In other variations, the means for spatially distributing primary light may comprise a grating, a diffuser, a mask, or the like. The optical waveguide, if present, may be configured to couple in light from a primary light source, to at least partially guide the coupled-in light in the core of the waveguide along a length of the waveguide, and to leak the coupled-in, guided primary light out of the waveguide core in a controlled manner, e.g., to leak the guided light out of the core gradually or continuously along the length of the waveguide, or at particular or discrete regions of the waveguide. The light that has been leaked out of the waveguide core comprises a spatially distributed light source that has been created from the incident primary light source. The leaked, spatially distributed light is then incident upon a photoluminescent material, which may in some variations comprise a combination of materials. The photoluminescent material is configured to at least partially absorb, i.e., be pumped by, the leaked light. After it absorbs the incident leaked light, the photoluminescent material emits a secondary light emission, e.g., by phosphorescence and/or fluorescence. As will be discussed in more detail below, the primary light that has been leaked out of the waveguide core may or may not leak out of the waveguide generally, e.g., in some cases a cladding of the waveguide may comprise a photoluminescent material that absorbs the primary light that has been leaked out of the core. The secondary light emission from the photoluminescent material may be in any desired wavelength range, e.g., visible and/or infrared. The secondary light emission from the devices may comprise red, green, blue, yellow and/or white light. The devices may be configured for use in a lighting fixture.

The primary light source used with the devices may be any suitable type of light source. For example, one or more lasers, e.g., laser diodes, LEDs, lamps, e.g., arc lamps, discharge lamps, fluorescent lamps, and the like may be used. In some variations, a primary light source may comprise more than one light source or more than one type of light source, e.g., more than one laser, more than one LED, or a laser and an LED. Primary light sources may be either continuous (e.g., continuous wave (CW) lasers) or pulsed (e.g., flashlamp-pumped, mode-locked, Q-switched, or cavity-dumped lasers). Shutters or optical choppers and the like may also be used to temporally modulate the primary light source. A primary light source may be part of a light-emitting device, e.g., adjoined as a component to a light-emitting device, or as an integral component of the light-emitting device. In some variations, a primary light source may be separate from the light-emitting device, and emission from the primary light source may be delivered to one or more light-emitting devices, e.g., a group of satellite light-emitting devices, using any suitable means or technique, e.g., optical fibers, mirrors, lenses, and the like.

In variations of light-emitting devices in which the primary light source comprises a laser, a semiconductor laser described herein, now known, or later developed may be used. In many variations, lasers having a relatively high electrical-to-optical conversion efficiency may be used to improve the overall efficiency of the light-emitting devices, and of light fixtures utilizing such light-emitting devices. For example, lasers having an electrical-to-optical conversion efficiency of at least about 40%, at least about 50%, or at least 60%, or even higher, e.g., at least about 70%, may be used. For example, a laser comprising GaN or a GaN alloy as a lasing medium may be used. In other variations, other direct band gap semiconductor lasers such as GaAs, AlGaAs, GaP, InGaAs, GaInNAs, InGaAsP, InP, and GaInP lasers may be used. In certain variations, a ZnO laser, e.g., a ZnO photonic crystal laser, may be used as a primary light source. Lasers used in the light-emitting devices described herein may have a variety of configurations. For example, in some variations, a semiconductor laser used as a primary light source may be an edge-emitting laser, or in-plane laser. In other variations, a semiconductor laser may be a surface-emitting laser. A semiconductor laser such as an edge-emitting or surface-emitting semiconductor laser may be separate from the light-emitting device, or may be part of the device itself, e.g., as an adjoined component, or as an integral component.

In some variations of devices, the primary light source may comprise one or more LEDs. The LEDs may be any suitable type of LED described herein, now known, or later developed, and may have any suitable composition and any suitable configuration. For example, LEDs may be GaN LEDs or GaN alloy LEDs. In other variations, LEDs may be AlGaAs, AlInGaP, InGaN, InP, GaInP, InGaAs, GaInNAs, ZnSe, or ZnO LEDs. Non-limiting examples of LEDs that may be used as primary light sources are provided in U.S. Patent Publication 2007/0222369, entitled “Light-emitting device and phosphor,” published Sep. 27, 2007, which is hereby incorporated herein by reference in its entirety. An LED may be a component that is part of a light-emitting device, e.g., as an adjoined component or as an integral component.

The primary light source may emit light of any suitable wavelength that is at least partially absorbed by the photoluminescent material. In some variations, the primary light source may emit light that has a wavelength in a range from about 200 nm to about 500 nm, e.g., about 250 nm, about 300 nm, about 350 nm, about 400 nm, about 450 nm, or about 500 nm. A semiconductor diode laser or a LED emitting over this wavelength range may be used. For example, a GaN or GaN alloy diode laser capable of emitting about 100 mW, about 200 mW, about 300 mW, or even more power, of blue-violet light having a wavelength of about 400 nm, about 410 nm, about 420 nm, about 430 nm, about 440 nm, about 450 nm, about 460 nm, about 470 nm, about 480 nm, about 490 nm, or about 500 nm may be used. GaN or GaN alloy LEDs or other LEDs emitting in the blue-violet range, e.g., about 400 nm, about 410 nm, about 420 nm, about 430 nm, about 440 nm, about 450 nm, about 460 nm, about 470 nm, or about 480 nm, about 490 nm, or about 500 nm may be used.

If present, an optical waveguide used in the devices may be any suitable type of waveguide. The optical waveguide may comprise a single mode waveguide region, e.g., for those devices in which the primary light source comprises a laser. In other variations, the optical waveguide may comprise a multi-mode waveguide region, e.g., a large core multi-mode waveguide region. Large core multi-mode waveguides may for example be used in those devices in which the primary light source is a light source emitting light with low coherence, such as an LED. The optical waveguide may comprise a combination of waveguide types, e.g., a waveguide may comprise a taper region wherein a large core region of the optical waveguide is tapered to a smaller core region of the optical waveguide. In some instances, the large core region that is tapered into a smaller core region may be a multi-mode waveguide.

Any suitable means or technique may be used to couple light from the primary light source into the waveguide. In some variations, the light source may be coupled into a waveguide by abutting the light source against a waveguide. This butt-coupling technique may be used for example, if the primary light source is a surface-mounted light source such as a laser diode and the waveguide is a planar or rectangular waveguide disposed on the identical or an adjacent surface, or an optical fiber that can be abutted against a surface-mounted light source. In certain variations, the devices may further comprise a coupler that is configured to couple the light from the primary light source into the waveguide. Any suitable coupler described herein, now known, or later developed may be used. Non-limiting examples of couplers include those selected from the group consisting of ball lens couplers, aspheric lens couplers, grating couplers, butt couplers, index couplers, reverse core waveguide taper couplers, direct couplers, e.g., Namiki-type spherical or cylindrical lensed fiber couplers, and combinations thereof.

As stated above, the waveguide may be configured to spatially distribute the in-coupled, guided primary light. For example, a waveguide may comprise one or more optical loss regions, e.g., disposed along its length, wherein each optical loss region is configured to divert at least a portion of the coupled-in, guided light out of the core of the optical waveguide to create spatially distributed light.

Waveguides may comprise a variety of types and configurations of optical loss regions to divert at least a portion of the coupled-in, guided primary light out of the core of the waveguide, so that the diverted or leaked light may be used to pump a photoluminescent material. The amount of optical loss associated with each optical loss region or group of optical loss regions may be tuned for a particular application and/or photoluminescent material. Further, a spatial distribution of optical loss regions along or around a waveguide may be adjusted for certain applications and/or photoluminescent materials. In many variations, it may be desired to illuminate a photoluminescent material with a peak intensity and/or peak power below a damage threshold of the photoluminescent material and/or a matrix material comprising the photoluminescent material, e.g., a polymer or glassy matrix comprising dispersed photoluminescent particles. To increase system efficiency and/or reduce the probability for pump-induced damage, a photoluminescent material may be pumped with a peak power and/or peak intensity that is below a saturation threshold of the photoluminescent material.

A variety of types of optical loss regions may be provided in a waveguide to spatially distribute in-coupled, guided light out of a core of a waveguide in a controlled manner. For example, waveguides may comprise one or more optical splitters and/or taps, so that the waveguide is configured to split at least a portion of the guided primary light into multiple beams. At least one of the split-off beams may be diverted from a core of the optical waveguide to pump a photoluminescent material. Alternatively or in addition, optical loss regions may comprise one or more scattering regions that are configured to scatter at least a portion of the guided primary light out of the core of the waveguide to excite a photoluminescent material. Such scattering regions may comprise one or more roughened regions and/or one or more graded index regions, where each graded index region is configured to scatter light out of the core of the waveguide.

In still other variations, an optical loss region may comprise at least one index-confinement region that has an index-confinement region configured to divert a desired amount of light out of the waveguide core. That is, an index-confinement region may have an index-confinement condition to divert a designated fraction of guided light out of a waveguide with each reflection at a core/cladding interface. For instance, an index-confinement region may have a weak index-confinement condition (i.e., a relatively small difference in index of refraction between the core and cladding at the wavelength of interest) that allows a substantial amount of guided light to be leaked out of the core. The intensity of light within the core decreases along the length of the waveguide as light is leaked from those weakly confining portions of the waveguide. In other variations, a waveguide may comprise a strong index-confinement region (i.e., a relatively large difference in index of refraction between the core and cladding at the wavelength of interest) that allows only a small amount of guided light to be leaked out of the core. Thus, the designated fraction of guided light loss due to the index-confinement condition may be selected to appropriately distribute the light loss along any desired length of a waveguide. For example, an index-confinement condition may be selected to be relatively weak to allow relatively large amounts of leakage over a relatively short length of the waveguide, or an index-confinement region may be selected to be relatively strong to allow relatively small amounts of leakage over a relatively long length of the waveguide. Non-limiting examples include variations in which an index confinement condition between the core and a cladding of the waveguide is configured so that about 2% or about 4% or about 6% or about 8% or about 10% of the primary light may be diverted out of the core with each reflection at a core/cladding interface. In some variations, weak index-confinement regions may be alternated with strong index-confinement regions along a length of the waveguide.

In certain variations, optical loss regions may comprise one or more bend regions, where light is leaked out of the core of the waveguide in a controlled manner in the bend regions. As stated above, some variations of waveguides may comprise a taper region, where a large core multi-mode region is tapered into a smaller core region, and light that is not coupled into the small core region, e.g., certain modes that do not couple into the smaller core, may be diverted out of the core of the waveguide and used to pump a photoluminescent material.

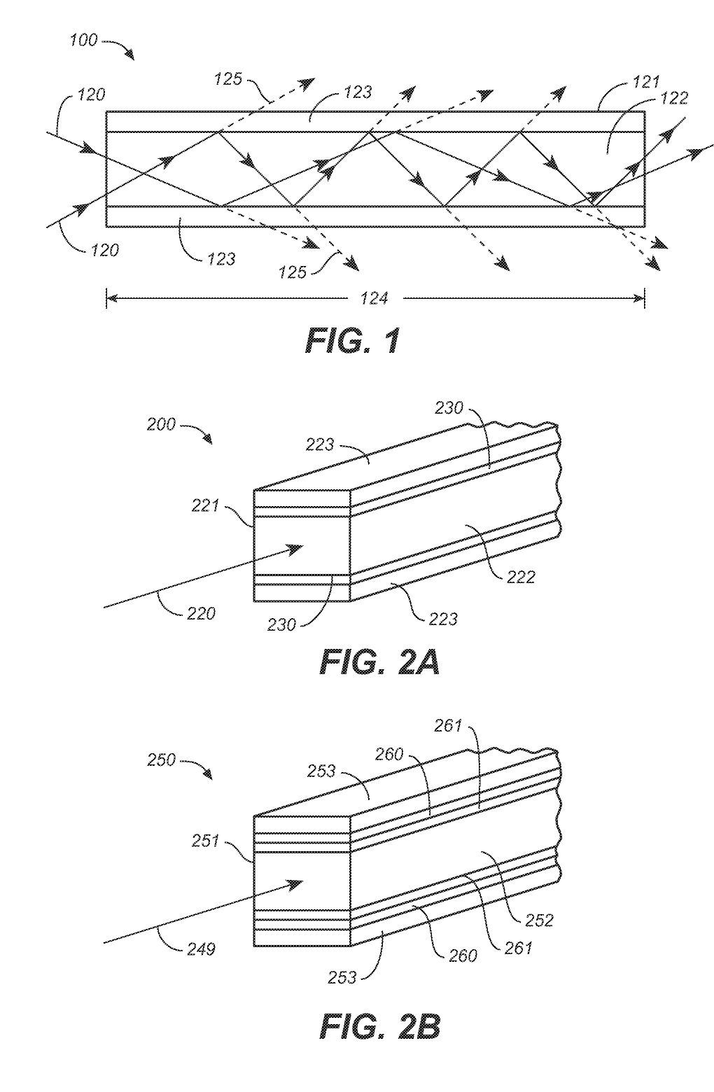

Referring now to FIG. 1, a variation of a light-emitting device 100 is shown. There, a beam 120 from a primary light source (not shown) is coupled into a waveguide 121. Although waveguide 121 is illustrated as a planar waveguide, waveguides may have any suitable configuration and may guide light using any suitable mechanism, e.g., rectangular waveguides, optical fibers, photonic crystal fibers, hollow core photonic crystal fibers, and the like may be used. The coupled-in light 120 is at least partially guided along a length 124 of the waveguide 121, in the core 122 between the cladding layers 123. The waveguide may be configured so that light is leaked out from the core of the waveguide in a controlled manner, and so that leaked light may be used to pump a photoluminescent material. In the particular variation shown in FIG. 1, leaked light 125 is leaked out of the core 122 and out of the waveguide 121 in general and is distributed along the length 124 of the waveguide 121. Note that the vertical sidewalls of a planar waveguide can scatter light out of the guiding region of the waveguide. The leaked light 125 may be used to pump a photoluminescent material (not shown), as will be described in more detail below. The photoluminescent material may be part of the waveguide itself, e.g., in a core and/or cladding region of the waveguide, or it may be disposed in a coating or sheath applied to the waveguide, or it may be disposed on a surface or other structure adjacent or near the waveguide to receive and at least partially absorb the light leaked out of the waveguide core or out of the waveguide in general.

The photoluminescent material may comprise any suitable type and/or arrangement of material. For example, phosphorescent materials described herein, now known, or later developed that may be pumped by light having wavelength in the range from about 250 nm to about 500 nm, and emit phosphorescence having a visible component, e.g., red, green, blue, yellow and/or white light, may be used. Some examples of suitable photoluminescent materials are described in U.S. Patent Publication 2007/0222369, entitled “Light-emitting diode and phosphor,” published Sep. 27, 2007, which has already been incorporated herein by reference in its entirety. For example, the photoluminescent material may comprise a phosphorescent compound selected from the group consisting of cerium-containing compounds, yttrium-containing compounds, gadolinium-containing compounds, scandium-containing compounds, lanthanum-containing compounds, lutetium-containing compounds, terbium-containing compounds, and combinations thereof. In many variations, the photoluminescent material may comprise an oxide. Non-limiting examples of photoluminescent materials include phosphors having the general formula (Ln_{1-a-b}CeₐTb_{b})₃M₅O₁₂, where Ln is an element of the selected from the group consisting of yttrium (Y), gadolinium (Gd), scandium (Sc), Lu (lutetium), and lanthanum (La), and M is a metal selected from the group consisting of aluminum (Al), gallium (Ga), and indium (In), e.g., (Y_{1-a-b}CeₐTb_{b})₃Al₅O₁₂ or (Gd_{1-a-b}CeₐTb_{b})₃Al₅O₁₂, where 0.001≦a≦0.3 and 0≦b≦0.5. Photoluminescent materials may comprise (Sr, Ca, Mg)Ga2S4:Eu and/or ZnS:Cu, Al which may in some variations emit green light. Some variations of photoluminescent materials may comprise (Ca, Sr)S:Eu which may emit red light. As stated above, the photoluminescent material may comprise a combination of materials, e.g., where each material in the combination is selected to emit light over a different part of the visible spectrum. Of course, other criteria for selecting photoluminescent materials may be used, e.g., solubility, long term stability, toxicity, efficiency, and the like.

The photoluminescent material may comprise a continuous layer or coating, or a discontinuous layer or coating. The photoluminescent material may comprise a composite material, e.g., photoluminescent particles dispersed in a matrix, e.g., a polymeric or glassy matrix. In some cases, the photoluminescent particles may comprise nanoparticles, e.g., particles having a dimension of about 100 nm or smaller. The photoluminescent materials may be mixed as powders or particulates into a resin, and applied to a substrate or other surface as a film. In some variations, the photoluminescent materials may be formed into a thin crystalline or polycrystalline layer. Devices may comprise more than one photoluminescent material, e.g., some devices may comprise a group of photoluminescent materials, with each photoluminescent material emitting light over different wavelength ranges of visible light, e.g., red, green, blue, yellow, and/or white light. Photoluminescent materials may comprise additional components, e.g., for particle dispersion and/or reflectivity, including BaSO₄, MgO and/or CaHPO₄.

In the devices and methods described here, the photoluminescent material may be arranged in any suitable manner relative to the waveguide in these devices. For example, in some variations, the photoluminescent materials may be incorporated into a cladding and/or a core of the waveguide. Referring now to FIG. 2A, light-emitting device 200 comprises a waveguide 221 configured to couple in and guide light 220 from a primary light source (not shown). In this variation, the optical waveguide 221 comprises one or more optical loss regions in the core 222 and/or at the interface between the core 222 and cladding 223 so that coupled-in and guided primary light 220 is diverted out of the core 222. Although waveguide 221 is portrayed as a planar waveguide in this variation for simplicity of illustration, any suitable type of waveguide may be used, e.g., a rectangular waveguide, an optical fiber, a photonic crystal fiber, a hollow core photonic crystal fiber, and the like. In this variation, a layer 230 containing a photoluminescent material has been coated onto the core 222 before the cladding 223 has been applied. In this way, light diverted out of the core 222 by the optical loss regions (e.g., roughened scattering regions) may excite the photoluminescent material 230, which in turn emits a secondary emission that in some variations comprises visible light. The photoluminescent material may in some cases serve a dual purpose of both altering (e.g., weakening) an index-confinement condition for the core and absorbing leaked light.

In certain instances, devices may comprise a waveguide that includes a thin buffer cladding layer interposed between a core and a photoluminescent material-containing layer, and a thicker cladding layer applied over the photoluminescent material-containing layer. The thin buffer cladding layer may comprise any suitable material now known or later developed, and may be selected to adjust (e.g., reduce) scattering by the photoluminescent material containing-layer and may also be based on the wavelength of light being guided. Referring now to FIG. 2B, a light-emitting device 250 is shown. This device variation includes a waveguide 251 that is configured to couple in and guide light 249 from a primary light source (not shown). A thin buffer cladding layer 261 is coated on the core 252. A layer 260 containing a photoluminescent material may be coated on the buffer layer 261. A thicker cladding layer 253 may be coated on the layer 260 containing a photoluminescent material. The optical waveguide 251 comprises one or more optical loss regions in the core 252 and/or at the interface between the core 252 and the buffer layer 261. Although the devices shown in FIGS. 2A and 2B are depicted as generally symmetrical top to bottom, other variations may include a different photoluminescent layer on the top versus the bottom, or a photoluminescent layer only on the top or bottom.

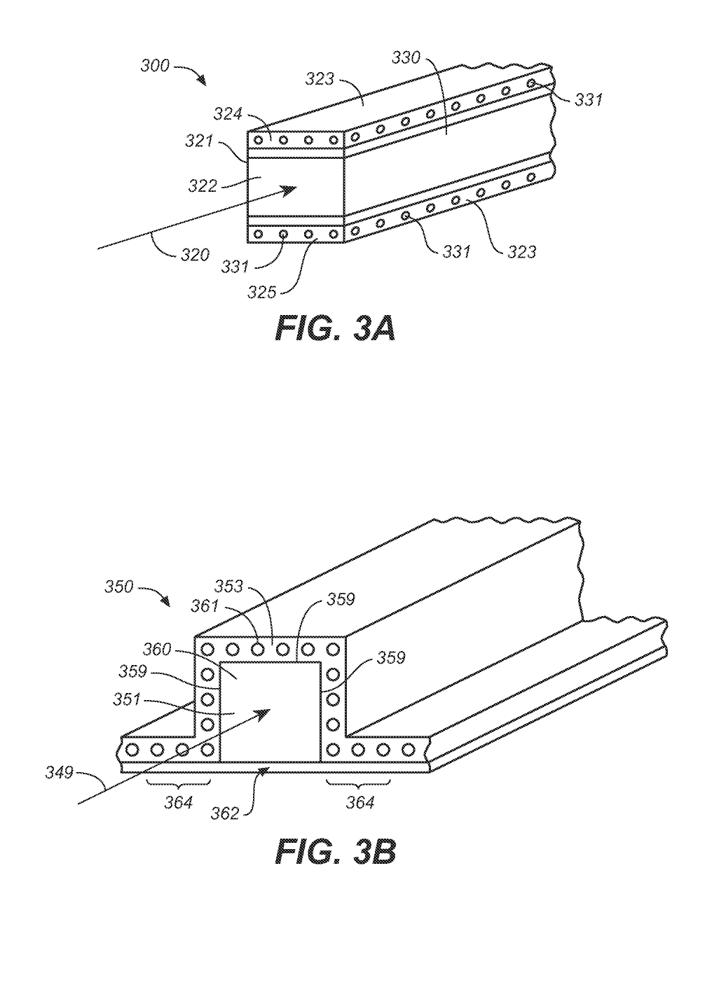

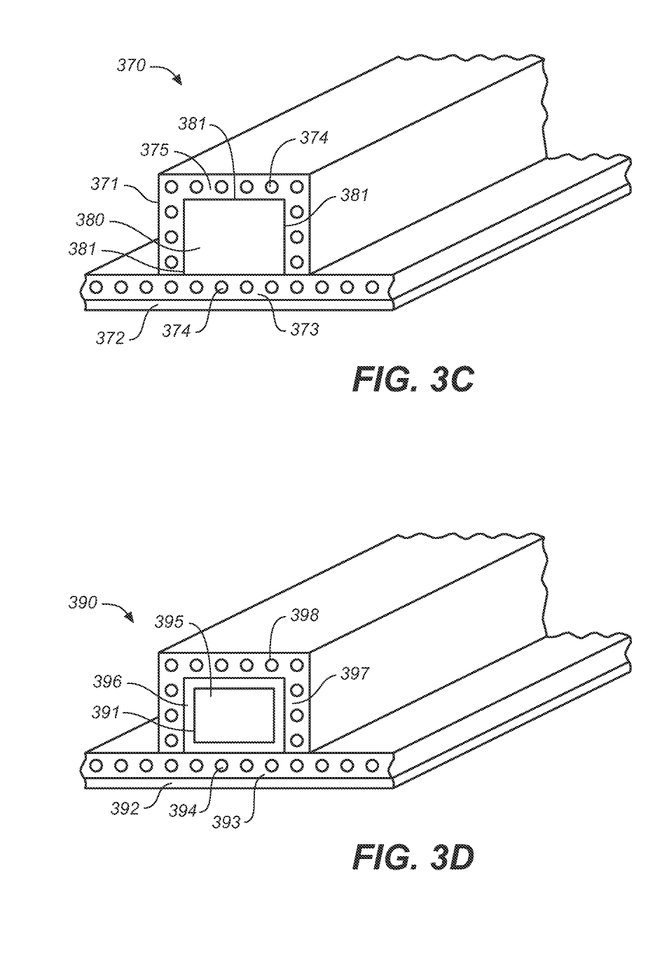

Referring now to FIGS. 3A-3D, additional variations of light-emitting devices comprising photoluminescent materials are shown. In FIGS. 3A-3C, examples of devices are shown that may not include a buffer cladding layer between a waveguide core and a photoluminescent material containing layer, whereas FIG. 3D illustrates an example of a device that may include a buffer cladding layer between a waveguide core and a photoluminescent material containing layer. Referring first to FIG. 3A, light-emitting device 300 comprises a waveguide 321 configured to couple in and guide primary light beam 320 from a primary light source (not shown). Similar to waveguides 221 and 251 in FIGS. 2A and 2B, respectively, waveguide 321 is depicted as a planar waveguide in this example for ease of illustration, but any suitable type of waveguide may be used, e.g., a rectangular waveguide, an optical fiber, a photonic crystal fiber, a hollow core photonic crystal fiber, and the like. The waveguide 321 comprises one or more optical loss regions (e.g., scattering regions) such that light guided in the core 322 is diverted out of the core into the cladding 323. In this variation, the cladding 323 comprises a photoluminescent material 331 that is capable of absorbing the primary light that has been diverted out of the core and emitting a secondary emission, which may comprise visible light. The photoluminescent material may be disposed in the cladding in any suitable form, e.g., as dispersed particles in a matrix, as a continuous or discontinuous layer, and/or in a layer offset from the core by a thin cladding buffer layer selected to control phosphor scattering losses in a desired manner. Although device 300 is depicted as having photoluminescent materials on both top 324 and bottom 325, the photoluminescent material on the top and bottom may be the same or different. Further, certain other device variations may comprise a photoluminescent material only on the top or the bottom.

Referring now to FIG. 3B, a device 350 comprising a rectangular waveguide is illustrated. There, rectangular waveguide 351 is mounted on a substrate 362 and comprises a core 360 surrounded on three sides by a cladding layer 353 that comprises a photoluminescent material 361. As shown, the photoluminescent material may in some variations extend outward from the sides of waveguide 351 onto the substrate 362 into a wing region 364. Such rectangular waveguides may be symmetrical on three sides 359 with respect to the photoluminescent material as illustrated, or asymmetrical, e.g., only one or two sides may contain a photoluminescent material, or one side may contain a different photoluminescent material than another side. Although not shown in this particular variation, a thin buffer cladding layer may be disposed between the core 360 and layer 353 comprising photoluminescent material 361.

In the example shown in FIG. 3C, device 370 comprises a rectangular waveguide 371 that may comprise a photoluminescent material around all four sides of the waveguide. There, substrate 372 comprises a base layer 373 comprising a photoluminescent material 374. A rectangular waveguide 371 is disposed on the layer 373. The rectangular waveguide 371 comprises a core 380 surrounded on three sides by a cladding layer 375. The cladding layer 375 may comprise a photoluminescent material 374. The base layer 373 may be the same as or different from the cladding layer 375. Similarly, the photoluminescent material contained in the base layer 375 and the cladding layer 373 may be the same or different. The photoluminescent material 374 disposed in the cladding layer may be uniformly distributed around three sides 381 of the waveguide 371, or be distributed preferentially along one or more sides.

FIG. 3D shows a variation of a device that is similar to that illustrated in FIG. 3C, except a thin cladding layer is shown between the waveguide core and a photoluminescent layer. Device 390 comprises a base layer 393 comprising a photoluminescent material 394 that has been deposited on a substrate 392. A rectangular waveguide 391 is disposed on the base layer 393. Similar to waveguide 371 in FIG. 3C, waveguide 391 comprises a core 395 surrounded on three sides by a cladding layer 397 that comprises a photoluminescent material 398. However, in this particular variation, a thin buffer cladding layer 396 is disposed between the core 395 and the cladding 397 and the base layer 393. The cladding 397 may be the same as or different than the base layer 393. Further, the photoluminescent material 394 in the base layer 393 may be the same or different as the photoluminescent material 398 in the cladding 397. Similar to the device variations shown in FIGS. 3A-3C, device 391 may be symmetrical or asymmetrical with respect to its sides. For any of the variations shown in FIGS. 3A-3D, a substrate supporting a device may be transparent to secondary light emission from the device.

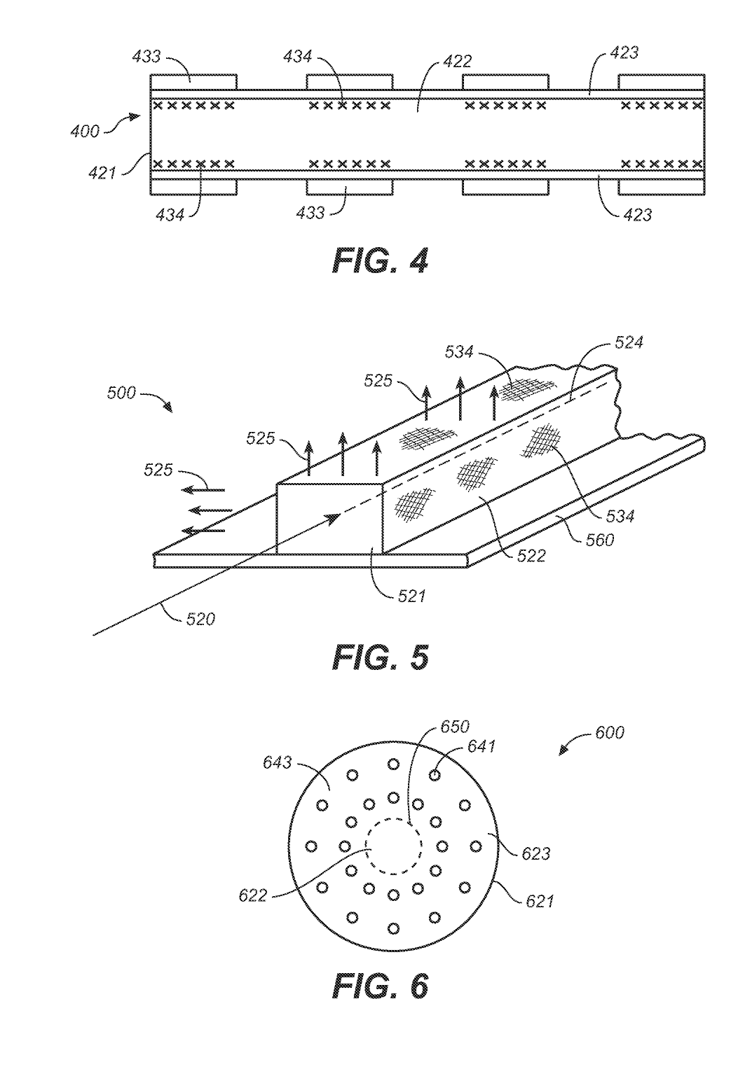

The photoluminescent material may comprise one or more photoluminescent regions, and a spatial distribution of the one or more photoluminescent regions may be at least partially coordinated with a spatial distribution of the distributed light loss emanating from the core of the waveguide or from the waveguide in general. In some variations, the photoluminescent material may be disposed along at least a portion of the length of the optical waveguide, e.g., either continuously or periodically. Referring now to FIG. 4, a variation of a light-emitting device 400 is shown. In this particular variation, device 400 comprises a waveguide 421 comprising a core region 422 and a cladding 423. Similar to waveguides 221, 251 and 321 in FIGS. 2A-2B and 3A, respectively, waveguide 421 is depicted as a planar waveguide, but may comprise any suitable type of waveguide, e.g., a rectangular waveguide, an optical fiber, a photonic crystal fiber, a hollow core photonic crystal fiber, and the like. The core 422 comprises one or more optical loss regions 434 such that primary light (not shown) that is guided along the core is diverted out of the core at or near the optical loss regions 434. Vertical sidewalls of planar waveguide 421 can also scatter light out of the guiding core of the waveguide in a radial manner. However, in any waveguide, any or all sides may have regions that provide various amounts of optical loss (e.g., regions comprising various amounts of roughening). Further, the optical loss regions may be distributed longitudinally and/or radially around a waveguide core. In this variation of light-emitting device, a coating applied to the exterior of the cladding 423 comprises one or more photoluminescent regions 433. The photoluminescent regions 433 may be spatially distributed in a coordinated manner with the optical loss regions 434.

In certain variations, the optical waveguide may comprise a central longitudinal axis extending along the length of the optical waveguide, and at least a portion of the distributed light may be emitted in a direction that is generally orthogonal to the central longitudinal axis. For example, the distributed light loss may be at least partially isotropic in two dimensions that are each generally orthogonal to the central longitudinal axis, e.g., the distributed light may be emitted generally radially from the central longitudinal axis. Referring now to FIG. 5, a device 500 comprises an optical waveguide 521, which may be an optical fiber. In this particular variation, the optical waveguide 521 is depicted as a rectangular waveguide mounted on a substrate 560. Primary light 520 is coupled into a core region 522 of the optical waveguide 521 and is at least partially guided in the core 522 along a central longitudinal axis 524 of the waveguide 521. The core region 522 of the optical waveguide 521 comprises one or more optical loss regions 534 (e.g., roughened or scattering regions) that may be arranged radially with respect to the central longitudinal axis 524 so that the distributed, e.g., scattered, light 525 is directed generally orthogonal to and radially outward from the central longitudinal axis 524. The distributed light 525 may be at least partially (or in some variations, substantially) isotropic in two dimensions that are generally orthogonal to the central longitudinal axis 524. Note that in some variations, an optical fiber may be used as the optical waveguide, and the core region 522 that guides the primary light 520 may be either hollow or solid.

As stated above, in some variations, a waveguide used in the light-emitting devices and methods described herein may comprise a photonic crystal fiber (a holey fiber). In photonic crystal fibers, the waveguide may comprise an optical fiber having a solid core surrounded by a cladding region comprising an array of separate but closely-spaced air-filled cavities or holes extending along the length of the fiber. The hole-filled cladding region may have a lower effective index of refraction than the solid core, leading to conventional waveguiding. Alternatively or in addition, in some photonic crystal fibers, a waveguiding mechanism may be based on the bandgap properties of the cladding, e.g., where light is confined in a solid core by a photonic bandgap created by the structured cladding. Regardless of the waveguiding mechanism, in variations of devices comprising a photonic crystal fiber, a photoluminescent material may be distributed within the matrix of the cladding region and/or in the cavities or holes in the cladding region. Referring now to FIG. 6, a light-emitting device 600 comprises a photonic crystal fiber 621. In this variation of device, a cladding region 623 surrounds a solid core region 622. The cladding region 623 comprises an array of closely-spaced holes or cavities 641. A photoluminescent material (not shown) may be distributed in the matrix material 643 of the cladding region 623, in the cavities 641, and/or in the core region 622, e.g., at or near the boundary 650 between the core region 622 and cladding 623.

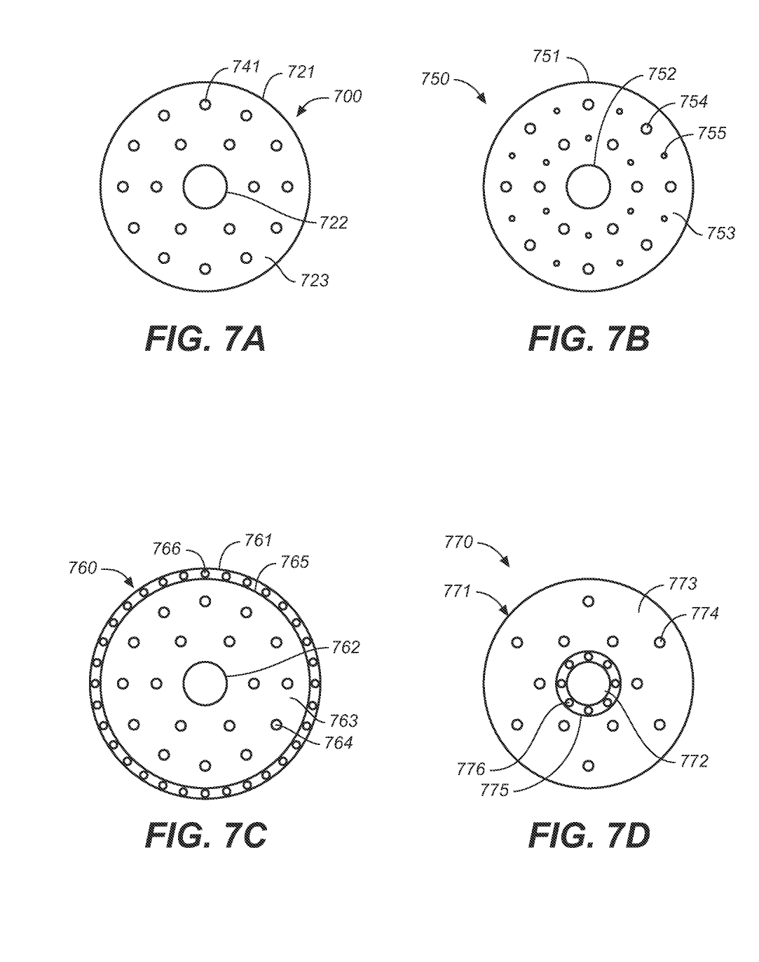

As stated above, a hollow lightpipe may be used to guide the primary light, and the photoluminescent material may be disposed in the light pipe, coated on an interior of the hollow guiding structure and/or coated on an exterior of the annular hollow light pipe. Any type of hollow light pipe may be used, e.g., any tubular material having its interior coated with a material designed to provide total internal reflection for certain wavelengths of light. For example, a hollow core photonic crystal fiber may be used in which a hollow core is surrounded by a cladding region comprising an array of separate but closely-spaced cavities or holes may be used to guide light within the hollow core, e.g., using a photonic band gap guiding mechanism. In these variations, the hollow core may comprise, e.g., be lined with, the photoluminescent material. Referring to FIG. 7A, a light-emitting device 700 comprises a hollow core photonic crystal fiber 721. In this variation of device, a hollow core 722 may function to guide light within the core, e.g., via a photonic band gap guiding mechanism. A cladding region 723 comprises an array of closely-spaced holes or cavities 741.

For light-emitting devices comprising a solid core photonic crystal fiber, e.g., as illustrated in FIG. 6, or a hollow lightpipe, e.g., as illustrated in FIG. 7A, the cladding region may comprise a photoluminescent material, e.g., be lined with, have photoluminescent particles distributed through at least a portion of the bulk of the cladding region, and/or have an exterior coating comprising a photoluminescent material. Variations of such devices are illustrated in FIGS. 7B-7D. In FIG. 7B, device 750 includes a hollow core photonic crystal fiber 751 that comprises a core 752 surrounded by cladding 753 that comprises closely-spaced holes 754. In this variation, one or more photoluminescent materials 755 may be dispersed in the cladding 753. In FIG. 7C, device variation 760 includes a photonic crystal fiber 761 that comprises a core 762 surrounded by cladding 763 that comprises closely-spaced holes 764. There, the cladding 763 is coated by an external layer 765 that comprises one or more photoluminescent materials 766. In the example shown in FIG. 7D, device 770 comprises a photonic crystal fiber 771 that comprises a core 772 surrounded by cladding 773 that comprises closely-spaced holes 774. A layer 775 that comprises one or more photoluminescent materials 776 is disposed between the core 772 and the cladding 773. In some variations, a thin cladding buffer layer (not shown) may be disposed between the core 772 and the photoluminescent layer 775. Although the photoluminescent material or materials in FIGS. 7B-7D are generally illustrated as one or more dopants in a matrix, in some variations, one or more photoluminescent materials may comprise one or more contiguous regions, e.g., as a layer or a partial layer.

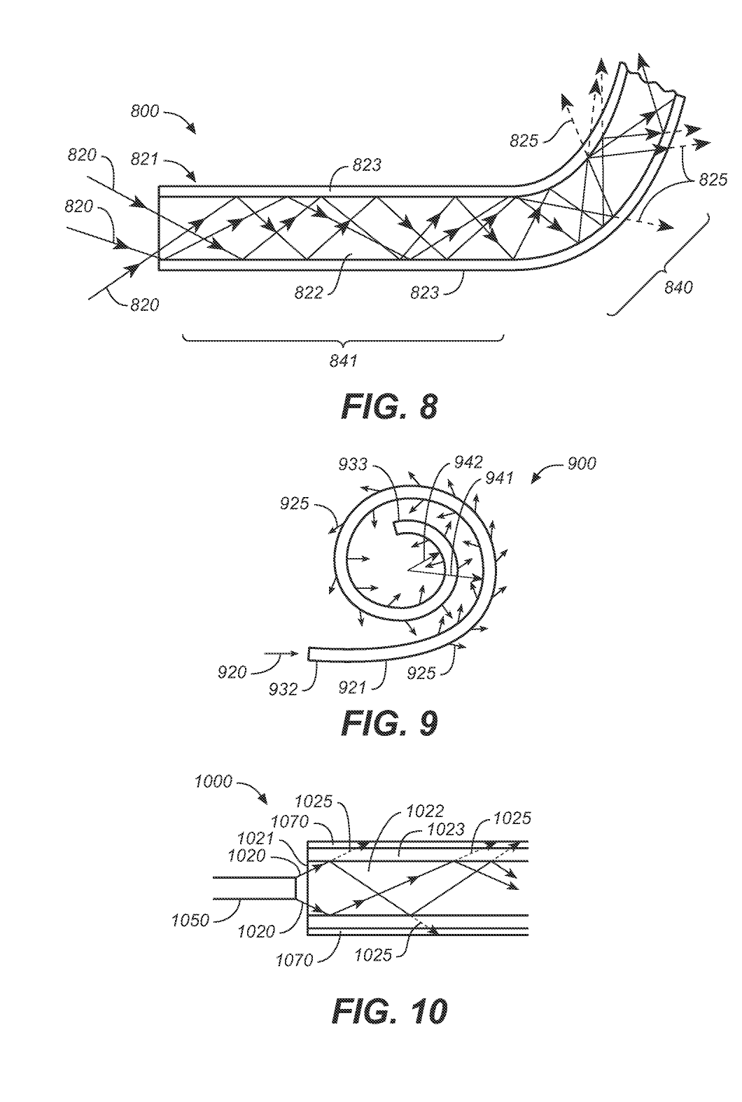

In some devices, the optical waveguide may comprise at least one bend region. In these variations, the distributed light loss used to pump the photoluminescent material may comprise light diverted out of the core of the optical waveguide from the at least one bend region. Referring now to FIG. 8, device 800 comprises a waveguide 821. Primary light beam 820 is coupled into the waveguide 821 and guided in the core 822 along the waveguide 821 through a relatively straight region 841 of the waveguide 821. As the guided light encounters the bend region 840, the angle of incidence against the interface between the core 822 and cladding 823 may be such that the guided light is not as well confined within the core region 822 by cladding 823. Thus light 825 may be leaked out of the waveguide core (and in some cases, out of the waveguide) in the bend region 840, and it is this leaked light 825 that may be used to pump a photoluminescent material. In certain instances, a sleeve or coating (not shown) comprising a photoluminescent material may be placed around bend region 840 to absorb leaked light 825 and emit a secondary emission that may comprise visible light.

In some variations of devices, the optical waveguide may comprise a coiled region between a proximal end and a distal end of the waveguide. The radius of curvature of the coiled region may be approximately constant between the proximal end and the distal end, e.g., to form a helical or spiral structure. In other variations, the radius of curvature of the coiled region may decrease from the proximal end to the distal end. Referring now to FIG. 9, device 900 comprises a waveguide 921 comprising a proximal end 932 and a distal end 933. Primary light 920 is coupled into the waveguide 921. Waveguide 921 is coiled such a radius of curvature 941 of the waveguide 921 near the proximal end 932 is greater than a radius of curvature 942 near the distal end 933. By controlling the radius of curvature of a coiled waveguide, the intensity of the leaked light 925 that is leaked along the coiled length of the waveguide 921 may be controlled. The leaked light 925 may be used to pump a photoluminescent material (not shown) that is distributed along the length of the waveguide, e.g., as a sheath, a coating, and/or as a dopant in the cladding.

As stated above, some variations of devices may comprise the primary light source. Referring now to FIG. 10, device 1000 comprises a primary light source 1050 and an optical waveguide 1021. Emission 1020 from the primary light source 1050 is coupled into the waveguide 1021 and at least partially guided along the core 1022 between the cladding layers 1023. The core 1022 comprises one or more optical loss regions (not shown), e.g. scattering regions, that cause light 1025 to be leaked out of the core region 1022 of the waveguide 1021 and to be absorbed by a photoluminescent material, e.g., that is disposed in a coating or sheath 1070 exterior to the cladding 1023. Although not shown for this particular variation, some devices may comprise an optical coupler to couple the primary light 1020 into the waveguide 1021. The primary light source 1050 and optical waveguide may be combined into device in any suitable manner, e.g., integrated components or adjoined components. For example, in some variations, both components may be surface mounted onto a substrate, while in other variations the primary light source may be a laser diode surface mounted onto a substrate and the optical waveguide may comprise one or more optical fibers coupled to the laser diode.

Some devices may further comprise one or more filters and/or other mechanical and/or optical elements to at least partially block and/or attenuate stray light having the same wavelength as the light from the primary light source. In particular, in devices in which the primary light source emits ultraviolet and/or near ultraviolet, it may be desirable to block and or attenuate stray light from the primary light source that is not used to pump the photoluminescent material for safety considerations. Stray or unwanted ultraviolet light may be damaging to humans, other beings, and/or property. In some variations, spatial filters or blocking plates may be used to block or attenuate stray or unwanted primary light, e.g., pinholes, diaphragms and the like. In certain variations optical filters may be used to block or attenuate stray or unwanted primary light. Such optical filters may be used in any configuration, but in some variations it may be desirable to pass the secondary emission through a bandpass or a cutoff filter to transmit the desired secondary emission and to block or attenuate undesired or stray primary light. Of course, other mechanical and/or optical elements in addition to or in place of optical filters may be used to separate the desired secondary emission to be used as a light source from the primary light, e.g., prisms, dichroic reflectors or other types of wavelength-selective reflectors, gratings and the light.

As stated above, the secondary emission from the devices described here may comprise visible light, e.g., red light, yellow light, blue light, green light, white light, or a combination thereof. These devices may in some variations be adapted for use in room lighting. In those variations, the luminous flux of the secondary emission of the devices may be selected to be at least as high as an incandescent or fluorescent bulb used in similar applications. Thus, the secondary emission from the devices may have a luminous flux of at least about 30 lumens to about 5000 lumens or even more, e.g., at least about 40 lumens, at least about 50 lumens, at least about 100 lumens, at least about 300 lumens, at least about 500 lumens, at least about 800 lumens, at least about 1000 lumens, at least about 2000 lumens, at least about 3000 lumens, at least about 4000 lumens, or at least about 5000 lumens.

### Methods for Generating Light

Methods for generating light, e.g., visible light, are also described here. In general, the methods comprise distributing light from a primary light source in a controlled manner over an area to create spatially distributed light and pumping a photoluminescent material with the distributed light so that the photoluminescent material emits a secondary light that may in some variations comprise visible light, e.g., red light, yellow light, blue light, green light and/or white light.

The methods may involve spatially distributing light from any suitable primary light source as described herein, now known, or later developed. The methods may comprise distributing primary light of any suitable wavelength to be at least partially absorbed by the photoluminescent material or combination of materials, and then re-emitted as secondary emission of a desired wavelength band, e.g., visible light. For example, the methods may involve distributing primary light having a wavelength in a range from about 250 nm to about 500 nm, e.g., about 250 nm, about 300 nm, about 350 nm, about 400 nm, about 450 nm, or about 500 nm. The methods may involve distributing continuous or pulsed primary light, or otherwise temporally modulated primary light. The methods may comprise distributing light from a diode laser, e.g., a semiconductor diode laser such as a GaN or GaN alloy diode laser, or an LED, e.g., a GaN or GaN alloy LED as described above. The methods may comprise distributing the light from the primary light source such at a peak intensity of the distributed light is below a damage and/or saturation threshold of the photoluminescent material being pumped.

In certain variations, the methods for generating light may comprise spatially distributing light from a primary light source using an optical waveguide as described herein, now known, or later discovered. Any type of optical waveguide may be used in the methods, e.g., single mode, multi-mode, planar waveguides, rectangular waveguides, optical fibers, hollow lightpipes, photonic crystal fibers, and the like. In some variations, combinations of waveguide types may be used, as described above. The methods may involve using an optical waveguide comprising one or more optical loss regions as described above with any suitable arrangement of photoluminescent material. The one or more optical loss regions may comprise one or more scattering regions, one or more index-confinement regions configured to allow a desired amount of light loss from the core of the waveguide, e.g., per unit length, one or more bends, one or more splitters, one or more tapered regions from a large core region, e.g., a large core multi-mode region, to a smaller core region, and the like.

The methods may utilize any suitable photoluminescent material. For example, any photoluminescent material described herein, now known, or later discovered, may be used. As stated above, the photoluminescent material may comprise a combination of materials. The methods may involve photoluminescent materials arranged in any suitable manner to at least partially absorb the distributed primary light. For example, the photoluminescent materials may be applied as a coating or sheath over at least a portion of a waveguide, or may be applied as part of a cladding or a core as described above. Photoluminescent materials may be particles imbedded in a matrix in some instances, e.g., a polymeric or glassy matrix. Some variations of the methods may comprise pumping more than one photoluminescent material, e.g., a combination of photoluminescent materials that are selected to emit in different parts of the visible spectrum so that the combination of emissions may comprise white light or near white light. Of course, other criteria for selecting photoluminescent materials may be used, e.g., solubility, long term stability, toxicity, efficiency, and the like.

Some methods may further comprise blocking and/or attenuating stray or unwanted primary light. These methods may be especially useful when the primary light has an ultraviolet or near ultraviolet emission so as to improve the safety of the methods by reducing or eliminating stray ultraviolet light that may be harmful to humans, other beings, or the surrounding environment. In some variations, the methods may include at least partially separating the desired secondary emission from the primary light by using one or more spatial and/or optical filters or other optical elements. Thus, methods may include the use of one or more spatial and/or optical filters to block and/or attenuate stray or unwanted light. For example, pin holes and/or iris diaphragms may be used to block or attenuate stray light. The methods may utilize optical filters such as bandpass or cutoff filters to block and/or attenuate stray primary light and/or to separate secondary emission from primary light. As stated above, other optical elements such as dichroic or otherwise wavelength-selected reflectors, gratings, prisms, and the like may be used to separate secondary emission from primary light, and/or to block or attenuate stray primary light.

The methods described herein may be used for generating visible light, e.g., red light, yellow light, blue light, green light, white light, or a combination thereof, for use in light fixtures or other room lighting devices. Thus, the methods may be used to generate secondary emission having a luminous flux comparable to that of an incandescent light bulb or fluorescent light bulb, e.g., at least about 30 lumens to over 5000 lumens, e.g., at least about 30 lumens, at least about 50 lumens, at least about 80 lumens, at least about 100 lumens, at least about 300 lumens, at least about 500 lumens, at least about 800 lumens, at least about 1000 lumens, at least about 2000 lumens, at least about 3000 lumens, at least about 4000 lumens, or at least about 5000 lumens.

### Methods for Making Light Sources

Methods for making light sources are also provided herein. In general, the methods comprise providing an optical waveguide that is configured to couple in light from a primary light source and to at least partially guide the coupled-in light along a length of the optical waveguide and divert at least a portion of the coupled-in light out of a core of optical waveguide to create spatially distributed light. The methods include configuring the spatially distributed light as a light source, e.g., a visible light source comprising red, yellow, blue, green and/or white light.

In some variations of these methods, configuring the spatially distributed light for use as a light source may comprise pumping a photoluminescent material with the spatially distributed light as described above, and using secondary emission from the photoluminescent material as the light source, e.g., a visible light source.

Any suitable type of optical waveguide may be used in these methods, e.g., planar or rectangular waveguides, optical fibers, hollow lightpipes, or photonic crystal fibers. In some variations, combinations of waveguide types may be used, as described above. Further, the methods may comprise providing any suitable type of coupler to couple the primary light into the optical waveguide, e.g., a ball lens coupler, an aspheric lens coupler, a grating coupler, a butt coupler, an index coupler, a reverse core waveguide taper coupler, a direct coupler such as a Namiki-type spherical or cylindrical lensed fiber coupler, and combinations thereof.

These methods may include providing one or more optical loss regions disposed along the length of the waveguide, wherein each optical loss region is configured to divert at least a portion of the coupled-in light out of the waveguide core (and, in some instances, out of the waveguide) to create the distributed light. In these variations, the methods may comprise providing any suitable type of optical loss region in the waveguide that causes coupled-in light to be diverted out of the waveguide core. For example, optical loss regions may comprise scattering regions, index-confinement regions having an index-confinement condition configured to provide for a desired amount of optical loss, e.g., per unit length, one or more bends, splitters, taper regions from a large core region, e.g., large core multi-mode region, to a smaller core region, and the like, as described above.

Some variations of the methods comprise forming a bend in an optical waveguide to provide an optical loss region. In these methods, the bend in the optical waveguide, which may be an optical fiber, may be formed by any suitable technique or means. In general, it may be desired to bend a waveguide with a minimal or reduced amount of twisting or change in dimension, e.g., diameter for an optical fiber, to enable a desired amount of control over the optical loss stemming from the bend. The methods may comprise forming the bend to a pre-determined bend radius to provide a desired amount of optical loss from the bend, as determined by the wavelength of the primary light source and the characteristics of the waveguide being used. For example, the methods may comprise forming the bend such that an index-confinement condition of the bend provides a desired amount of optical loss from the bend.

In some instances, a bend in a waveguide may be formed by exposing a bend portion of the optical waveguide to a spark discharge to locally heat the bend portion of the optical waveguide, and bending the bend portion to form the bend. A pressurized gas jet may be used in combination with the spark discharge to aid in the bending process. Bends having any suitable angle, e.g., to provide a desired amount of optical loss may be formed, e.g., bends of about 20°, about 30°, about 40°, about 50°, about 60°, about 70°, or about 80°. Examples of the use of a spark discharge to bend silica waveguides are described in R. S. Taylor, K. E. Leopold, M. Wendman, G. Gurley and V. Elings, “Bent-fiber near-field scanning optical microscopy probes for use with commercial atomic-force microscopes”, Proc. SPIE Vol. 3009, 119-129 (1997), which is hereby incorporated by reference in its entirety. In these methods, a mold and/or a fixture comprising a bend (e.g., an electrically conductive mold and/or fixture) may be used to control bending of a fiber while the fiber is exposed to the electrical arc. For example, a fiber may be extended past the bend of an electrically conductive mold or fixture, and an electrical arc may be locally applied to that extended region of the fiber. A pressurized gas jet may be applied against the extended region fiber softened by the arc to assist in bending the fiber against the bend in the mold or fixture.

Alternatively or in addition, providing one or more optical loss regions in the waveguide may comprise providing one or more roughened regions in the optical waveguide. Such roughened regions may be formed using any suitable means or technique. For example, one or more roughened regions may be formed by etching and/or mechanically roughening, e.g., plasma etching, ion bombardment, sputter etching, wet etching, grinding, sanding, texturing, melt texturing, cutting, sawing, drilling, milling, or combinations thereof.

### Light Fixtures

Light fixtures are also provided herein. In general, these light sources comprise a visible light source and a light fixture body. The visible light source comprises an optical waveguide configured to couple in light from a primary light source, to at least partially guide the coupled-in light along the waveguide, and to divert at least a portion of the coupled-in light out of a core of the waveguide in a controlled, distributed manner. The visible light source also comprises a photoluminescent material that is configured to be pumped by the distributed light loss from the waveguide core or from the waveguide in general. As a result of being pumped by the distributed light loss, the photoluminescent material emits a secondary light emission that comprises visible light. Thus, the light fixtures may comprise any light-emitting device described herein, or a combination of the light-emitting devices described herein, as a visible light source.

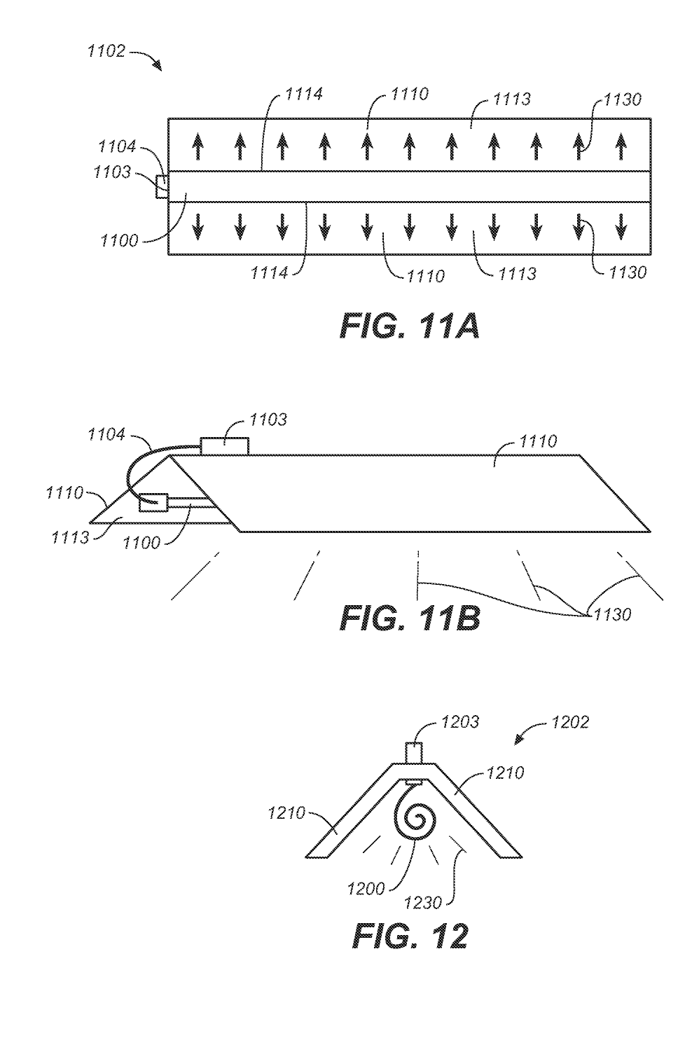

The light fixtures may comprise elements known in the art to direct, condition, focus, filter, diffuse, modulate, or otherwise modify light from the light from the light source. For example, the light fixture body of some light fixtures may comprise one or more reflective elements configured to direct the light from the visible light source. Referring now to FIGS. 11A-11B, light fixture 1102 comprises a visible light source 1100 and a light fixture body 1110. Emission, e.g., ultraviolet emission, from a primary light source 1103 is coupled into the visible light source 1100, e.g., using a coupler 1104, which may be flexible. The primary light source may in some variations be part of the light fixture, e.g., as an integral component or as an adjoined component. In other variations, the primary light source may be remote from the light fixture, and piped in, e.g., via optical fiber, to a network of light fixtures. The visible light source 1100 comprises a photoluminescent material and spatially distributes the light from the primary light source 1102 to be incident on and at least partially absorbed by the photoluminescent material. The photoluminescent material then emits secondary emission 1130, which may comprise visible light. The light fixture body 1110 may comprise reflective elements 1113 that may be configured to direct the secondary emission 1130 from the visible light source. In this particular variation, the visible light source 1100 is depicted as an elongated light source, with the secondary emission 1130 emanating from longitudinal sides 1114 of the visible light source 1110. Other variations and configurations may be used, e.g., where the visible light source comprises a cylindrically-shaped elongated visible light source, analogous to a fluorescent light bulb, or a bundle of optical fibers.

A light fixture may comprise a compact visible light source, e.g., a spiral or helical light source, or a coiled light source similar to that shown in FIG. 9. In the variation of the light fixture 1202 shown in FIG. 12, a compact visible light source 1200 is positioned in a light fixture body 1210 that comprises a reflective hood for directing the emission 1230 from the visible light source 1200 for use, e.g., as room lighting.

The light fixtures may be configured to be pumped with any suitable primary light source, e.g., one or more lasers or one or more LEDs as described above. Primary light sources emitting in the wavelength range from about 250 nm to about 500 nm, e.g., about 250 nm, about 300 nm, about 350 nm, about 400 nm, about 450 nm, or about 500 nm. For example, in some variations, a semiconductor laser such as a GaN laser or GaN alloy laser may be used as a primary light source. Any suitable photoluminescent material may be used in the light fixtures, e.g., photoluminescent materials described herein, now known, or later discovered. More than one photoluminescent material may be used in a single light fixture, e.g., to produce a combination of visible emission spectra that may together make white light or near white light.

The light fixtures may be configured to emit a luminous flux that is usable for room lighting applications. For example, the light fixtures may be configured to emit at least about 30 lumens to more than about 5000 lumens, e.g., at least about 30 lumens, at least about 50 lumens, at least about 80 lumens, at least about 100 lumens, at least about 300 lumens, at least about 500 lumens, at least about 800 lumens, at least about 1000 lumens, at least about 2000 lumens, at least about 3000 lumens, at least about 4000 lumens, or at least about 5000 lumens.

This disclosure is illustrative and not limiting. Further modifications will be apparent to one skilled in the art in light of this disclosure and such modifications are intended to fall within the scope of the appended claims. Each publication and patent application cited in the specification is incorporated herein by reference in its entirety as if each individual publication or patent application were specifically and individually put forth herein.

What is claimed is:

1. A device comprising:
an optical waveguide configured to couple in primary laser light, to at least partially guide the coupled-in laser light along a length of a core of the optical waveguide, and to leak guided laser light out of the core in a controlled manner; and
a photoluminescent material configured to be pumped by the leaked laser light and to emit a secondary light emission that comprises visible light.

2. The device of claim 1, wherein the optical waveguide is configured to couple in primary laser light emitted from a semiconductor laser.

3. The device of claim 2, wherein the optical waveguide is configured to couple in primary laser light emitted from a laser comprising gallium nitride or an alloy of gallium nitride as a lasing medium.

4. The device of claim 1, wherein the primary laser light has a wavelength in a range from about 250 nm to about 500 nm.

5. The device of claim 1, wherein the secondary emission from the photoluminescent material comprises white light.

6. The device of claim 1, further comprising one or more filters configured to at least partially attenuate and/or block stray light having the same wavelength as the primary laser light.

7. The device of claim 1, configured for use in a lighting fixture.

8. A device comprising:
an optical waveguide configured to couple in light from a primary light source, to guide at least a portion of the coupled-in light along a length of the optical waveguide, and to divert at least a portion of the guided light out of a core of waveguide to provide distributed light loss; and
a photoluminescent material configured to be pumped by the distributed light loss and to emit a secondary light emission that comprises visible light.

9. The device of claim 8, further comprising the primary light source.

10. The device of claim 8, wherein the light from the primary light source has a wavelength in a range from about 250 nm to about 500 nm.

11. The device of claim 8, wherein the optical waveguide is configured to split at least a portion of the guided light into multiple beams, and at least one of the multiple beams is diverted from the core to provide at least a portion of the distributed light loss.

12. The device of claim 11, comprising one or more splitters and/or taps to split at least a portion of the guided light into multiple beams.

13. The device of claim 8, wherein the optical waveguide comprises one or more scattering regions that are configured to scatter at least a portion of the guided light and to divert at least a portion of the scattered light out of the core of the waveguide to pump the photoluminescent material.

14. The device of claim 8, wherein the optical waveguide comprises at least one index-confinement region having an index-confinement condition configured to provide a desired amount of leakage of the guided light from the core of the waveguide, and the distributed light loss comprises light leaked out of the core of the waveguide from the at least one index-confinement region.

15. The device of claim 8, wherein the optical waveguide comprises one or more photonic crystal fibers.

16. The device of claim 8, wherein the optical waveguide comprises at least one bend region, and the distributed light loss comprises light diverted out of the core of the waveguide from the at least one bend region.

17. The device of claim 8, wherein the photoluminescent material comprises one or more photoluminescent material regions, and a spatial distribution of the one or more photoluminescent material regions is at least partially coordinated with a spatial distribution of the distributed light loss.

18. The device of claim 8, wherein the photoluminescent material is disposed along at least a portion of the length of the optical waveguide.

19. The device of claim 18, wherein the photoluminescent material is continuously disposed along the at least a portion of the length of the optical waveguide.

20. The device of claim 18, wherein the photoluminescent material is periodically disposed along the at least a portion of the length of the optical waveguide.

21. The device of claim 8, wherein the distributed light loss is at least partially isotropic in two dimensions that are each generally orthogonal to the central longitudinal axis.

22. The device of claim 8, wherein the distributed light loss is emitted generally radially from the central longitudinal axis.

23. The device of claim 8, wherein the optical waveguide comprises a central core region configured to guide the primary light and an annular guiding structure that surrounds the central core and comprises the photoluminescent material, and at least a portion of the distributed light loss is directed outward from the central core to the annular guiding structure comprising the photoluminescent material.

24. The device of claim 13, wherein the one or more scattering regions comprise one or more roughened regions, and each roughened region is configured to scatter at least a portion of the guided light.

25. The device of claim 13, wherein the one or more scattering regions comprise one or more graded index regions, and each graded index region is configured to scatter at least a portion of the guided light.

26. The device of claim 8, wherein the optical waveguide is configured to couple in light from a semiconductor laser.

27. The device of claim 26, wherein the optical waveguide is configured to couple in light from a laser comprising gallium nitride or an alloy of gallium nitride as a lasing medium.

28. The device of claim 8, wherein the optical waveguide is configured to couple in light from a light-emitting diode.

29. The device of claim 8, wherein the optical waveguide comprises a large core, multi-mode region.

30. The device of claim 8, wherein the optical waveguide comprises a taper wherein a large core region is tapered to a smaller core region.

31. The device of claim 30, wherein light not accepted by the smaller core region is used to pump the photoluminescent material.

32. The device of claim 8, wherein the distributed light loss has a substantially constant intensity along at least a portion of the length of the optical waveguide.

33. The device of claim 16, wherein the optical waveguide comprises a proximal end and a distal end, and the at least one bend region comprises a coiled region.

34. The device of claim 33, wherein the coiled region comprises a radius of curvature that decreases from the proximal end to the distal end.

35. The device of claim 8, wherein a peak intensity of the distributed light loss is below a damage threshold of the photoluminescent material.

36. The device of claim 8, wherein a peak intensity of the distributed light loss is below a saturation threshold of the photoluminescent material.

37. The device of claim 8, wherein the secondary light emission from the photoluminescent material comprises white light.

38. The device of claim 8, configured for use in a lighting fixture.

39. The device of claim 8, wherein the secondary emission has a luminous flux of at least about 30 lumens.

40. The device of claim 8, further comprising one or more filters configured to at least partially attenuate and/or block stray light having the same wavelength as the light from the primary light source.

41. The device of claim 8, further comprising one or more filters configured to at least partially separate the secondary emission from light having the same wavelength as the light from the primary light source.

42. The device of claim 8, wherein the photoluminescent material is disposed in and/or on the core of the optical waveguide.

43. The device of claim 8, wherein the photoluminescent material is disposed in and/or on a cladding of the optical waveguide.

44. The device of claim 8, wherein the photoluminescent material comprises particles dispersed in a matrix.

45. The device of claim 8, wherein the photoluminescent material comprises a compound selected from the group consisting of: cerium-containing compounds, yttrium-containing compounds, gadolinium-containing compounds, scandium-containing compounds, lanthanum-containing compounds, lutetium-containing compounds, terbium-containing compounds, and combinations thereof.

46. The device of claim 8, wherein the photoluminescent material is configured to emit secondary light emission that comprises yellow light, red light, green light, white light, or a combination thereof upon pumping by the distributed light loss.

47. The device of claim 8, further comprising a coupler configured to couple the light from the primary light source into the waveguide, wherein the coupler is selected from the group consisting of a ball lens coupler, an aspheric lens coupler, a grating coupler, a butt coupler, an index coupler, a reverse core waveguide taper coupler, a direct coupler such as a Namiki-type spherical or cylindrical lensed fiber coupler, and combinations thereof.

48. A method for generating light, the method comprising:
coupling light from a primary light source into an optical waveguide so that the coupled-in light is guided along a length of the optical waveguide; and
pumping a photoluminescent material with guided light that has been leaked from a core of the optical waveguide so that the photoluminescent material emits a secondary light emission that comprises visible light.

49. The method of claim 48, comprising pumping the photoluminescent material with an intensity of leaked light that is below a damage threshold of the photoluminescent material.

50. The method of claim 48, wherein the primary light source comprises a semiconductor laser.

51. The method of claim 48, wherein the primary light source comprises a laser comprising gallium nitride or an alloy of gallium nitride as a lasing medium.

52. The method of claim 48, wherein the primary light source comprises a light-emitting diode.

53. The method of claim 48, wherein the light from the primary light source has a wavelength in a range from about 250 nm to about 500 nm.

54. The method of claim 48, comprising pumping the photoluminescent material with light leaked from the optical waveguide so that the secondary light emission from the photoluminescent material comprises white light.

55. The method of claim 48, further comprising at least partially blocking and/or attenuating stray light having the same wavelength as the light from the primary light source.

56. The method of claim 48, further comprising at least partially separating the secondary light emission from light having the same wavelength as the light from the primary light source.

57. The method of claim 48, wherein the optical waveguide comprises one or more photonic crystal fibers.

58. The method of claim 48, comprising splitting a portion of the guided light and diverting the split portion from the core of the optical waveguide to provide at least a portion of the leaked light used to pump the photoluminescent material.

59. The method of claim 48, comprising scattering guided light out of the core of the waveguide to provide at least a portion of the leaked light used to pump the photoluminescent material.

60. The method of claim 48, wherein the optical waveguide comprises one or more bend regions configured to leak guided light out of the core of the optical waveguide.

61. A method for generating light, the method comprising:
distributing light from a primary light source over an area to create spatially distributed light; and
pumping a photoluminescent material with the spatially distributed light so that the photoluminescent material emits a secondary light emission that comprises visible light.

62. The method of claim 61, comprising distributing the light from the primary light source to provide a substantially uniform light intensity over the area.

63. The method of claim 61, comprising distributing light from a laser.

64. The method of claim 61, comprising distributing light from a light-emitting diode.

65. The method of claim 61, comprising distributing the light from the primary light source such that a peak intensity of the spatially distributed light is below a damage threshold of the photoluminescent material.

66. The method of claim 61, comprising distributing the light from the primary light source such that a peak intensity of the spatially distributed light is below a saturation threshold of the photoluminescent material.

67. The method of claim 61, comprising pumping the photoluminescent material with the spatially distributed light so that the secondary light emission has a luminous flux of at least about 30 lumens.

68. A method of making a light source, the method comprising:
providing an optical waveguide that is configured couple in primary light, to at least partially guide the coupled-in light along a length of the optical waveguide, and to divert at least a portion of the guided light out of a core of the optical waveguide to create spatially distributed light; and
configuring the spatially distributed light for use as a light source.

69. The method of claim 68, comprising providing one or more optical loss regions disposed along the length of the waveguide, wherein each optical loss region is configured to divert at least a portion of the guided light out of the core of the optical waveguide to create at least a portion of the spatially distributed light.

70. The method of claim 68, wherein configuring the spatially distributed light for use as a light source comprises pumping a photoluminescent material with the spatially distributed light and using emission from the photoluminescent material as the light source.

71. The method of claim 69, wherein providing one or more optical loss regions comprises forming a bend in the optical waveguide.

72. The method of claim 71, comprising forming the bend by exposing a bend portion of the optical waveguide to a spark discharge to locally heat the bend portion of the optical waveguide, and bending the bend portion to form the bend.

73. The method of claim 71, comprising using a mold and/or a fixture to control bending of the bend portion.

74. The method of claim 71, comprising forming the bend to a pre-determined bend radius to provide a desired amount of optical loss from the bend.

75. The method of claim 71, comprising forming the bend such that an index-confinement condition of the bend provides a desired amount of optical loss from the bend.

76. The method of claim 69, wherein providing one or more loss regions comprises forming one or more roughened regions in the optical waveguide.

77. The method of claim 75, comprising forming the one or more roughened regions by etching and/or mechanical roughening.

78. The method of claim 77, comprising forming the one or more roughened regions by plasma etching, ion bombardment, sputter etching, wet etching, grinding, sanding, texturing, melt texturing, cutting, sawing, or combinations thereof.

79. The method of claim 68, comprising providing a coupler to couple the primary light into the optical waveguide, wherein the coupler is selected from the group consisting of a ball lens coupler, an aspheric lens coupler, a grating coupler, a butt coupler, an index coupler, a reverse core waveguide taper coupler, a direct coupler, a Namiki-type spherical or cylindrical lensed fiber coupler, and combinations thereof.

80. A light fixture comprising:
a visible light source comprising:
an optical waveguide configured to couple in light from a primary light source, to at least partially guide the coupled-in light along a length of the waveguide, and to divert at least a portion of the guided light out of a core of the waveguide to provide distributed light loss; and
a photoluminescent material configured to absorb the distributed light loss and to emit a secondary light emission that comprises visible light; and
a light fixture body.

81. The light fixture of claim 80, wherein the light fixture body comprises one or more reflective elements configured to direct the visible light emitted by the photoluminescent material.

82. The light fixture of claim 80, comprising the primary light source.

83. The light fixture of claim 80, wherein the visible light source is configured to have an elongated shape.

84. The light fixture of claim 80, configured for providing a luminous flux of at least about 30 lumens.

85. The light fixture of claim 80, comprising one or more filters configured to at least partially block and/or attenuate stray light having the same wavelength as the light from the primary light source.

86. The light fixture of claim 80, wherein the light from the primary light source has a wavelength in a range from about 250 nm to about 500 nm.

87. The light fixture of claim 80, wherein the secondary emission comprises white light.

88. The light fixture of claim 80, wherein the secondary emission comprises yellow light, red light, green light, white light, or a combination thereof.

89. The light fixture of claim 80, wherein the primary light source comprises a semiconductor laser.

90. The light fixture of claim 80, wherein the primary light source comprises a light-emitting diode.

91. The light fixture of claim 80, configured for room lighting.
